(19) United States
(12) Patent Application Publication
(10) Pub. No.: US 2010/0275791 A1
(43) Pub. Date: Nov. 4, 2010

(54) Food Heating Arrangement

(76) Inventors: Ken Board, Swansea (GB); Alun Rhys Board, Swansea (GB)

Correspondence Address: WADDEY & PATTERSON, P.C., 1600 DIVISION STREET, SUITE 500, NASHVILLE, TN, 37203, US

(21) Appl. No.: 12/680,822

(22) PCT Filed: Oct. 2, 2008
(86) PCT No.: PCT/GB08/03330

§ 371 Date: Jul. 7, 2010

(30) Foreign Application Priority Data
Oct. 2, 2007 (GB) 0719222.2

(51) Int. Cl. A47J 36/00

(52) U.S. Cl. 99/447

(57) ABSTRACT

A liquid distribution arrangement (11, 14, 32, 33, 38) is situated internally of a container (17, 31) for liquid and acts to raise the liquid held in the container (17, 31) to be distributed over a food heating zone from above. The arrangement defines an enclosure about the food heating zone and is provided with one or both of a lid (39), arranged to engage with the liquid distribution arrangement (32, 33, 38) to hold the liquid distribution arrangement in place within the container (31),-and/or, a percolation device (14, 38) positioned above the food heating zone and including percolation apertures (15), enabling the heating liquid being distributed over the percolation device (14, 38) to pass through the percolation element (14, 38) and fall under gravity to heat the food at the heating zone.

This invention relates generally to a food heating arrangement and, more particularly, to a an arrangement having a percolation mechanism for heating and/or cooking food such as, for example vegetables.

In general, foods such as vegetables are cooked using a conventional saucepan on a cooker ring. The food is placed inside the saucepan and immersed in water, which is heated to a temperature such that it boils. The temperature of the water is sustained for the required time until the food is cooked. The cooked food is then removed from the saucepan and the water is disposed of.

There are a number of disadvantages associated with the conventional method of cooking food. Firstly, in many instances, the amount of water used to boil, for example, vegetables in a saucepan is greatly in excess of the minimum water required. Secondly, the water has a large thermal capacity and the thermal energy stored is also large and is generally discarded after cooking is achieved. Finally, the energy required to boil the water, related to the latent heat of vaporisation, is also large. As a consequence significant time and energy is required to achieve the end result of cooking the vegetables.

U.S. Pat. No. 5,586,487 describes a device and method for automatically cooking and draining food, for example pasta, rice or noodles. The device consists of an outer housing made of an electrically and thermally non-conductive material that stores water at its base and uses a central conduit to transfer hot water, heated by the heating element at its base, to the top of the container where it showers the food that is stored in the food retaining means. This process is continuous and, along with a slight positive cooking pressure, is used to cook the food for a pre-set amount of time.

International Patent Application No. WO 00/10440 describes a turkey baster consisting of a container in which the meat is placed, with at least one tube extending from the container having a top end coupled to a perforated plate, whereby the holes at the base of said perforated plate are raised such that the liquid substantially covers the plate before draining onto the meat.

While the systems described above are effective in providing the means to cook food there is a constant drive to reduce the amount of time and energy to achieve the end result. For example, the showering technique in U.S. Pat. No. 5,586,487 may not distribute the water evenly over the food stored in the food retaining means, causing the food to be cooked at different rates. As a result, the water may need to be heated for longer and some of the food may be overcooked. Additionally there is the requirement for the device to be completely enclosed during operation in order to obtain a slight positive pressure to aid the cooking process. This removes the option for the user to manually monitor the state of the food.

International Patent Application No. WO 00/10440 improves on the distribution of the liquid over the food, but at the expense of using excess liquid, which is stored on a top plate.

It is an object of the present invention to provide an improved cooking device for cooking food that enables the amount of liquid required to be minimised. As a consequence, the amount of energy required to achieve the end result is reduced.

In accordance with the present invention, there is provided food heating apparatus comprising:
a container for containing liquid, the container including a base and one or more sidewalls extending upwardly from the base;
a liquid distribution arrangement situated internally of the container, for raising the liquid held in the container to be distributed over a food heating zone from above;
wherein the arrangement defines an enclosure about the food heating zone and further comprises:
a lid arranged to engage with the liquid distribution arrangement to hold the liquid distribution arrangement in place within the container; and/or,
a percolation element positioned above the food heating zone and including a plurality of percolation apertures, the heating liquid being distributed over the percolation element to pass through the percolation element and fall under gravity to heat the food at the heating zone.

In one embodiment, a food receiving receptacle is located within the container, and the distribution arrangement directs the liquid to flow over a side of the food receiving receptacle and through the percolation element.

The enclosure is defined by a sidewall (or sidewalls) extending about the food heating zone and extending upwardly for an extent that rises above the level of the food situated at the heating zone. In one embodiment the enclosure is defined by the wall or walls of the container. In an alternative embodiment the enclosure may be defined by the wall or walls of a food receiving receptacle placed in the container. The enclosure may be capped by a lid or the percolation element (acting as a lid) or a lid or cover provided above the percolation element. It is preferred that the enclosure sidewall (or sidewalls) extend upwardly to substantially the position of the percolation element or above.

In a preferred embodiment the liquid distribution arrangement comprises a base portion arranged to rest on the container base. The base portion may provide a platform upon which the food to be heated may rest.

Preferably, the base portion is provided with one or more liquid communication conduits permitting liquid communication via the base from the container to the liquid distribution arrangement.

The arrangement preferably provides one or more conduits for raising the water from a lower portion of the container to be distributed from above the food heating zone.

In one embodiment, the one or more conduits are defined at the periphery of the liquid distribution arrangement.

In one embodiment, a food receiving receptacle is located within the container, and the distribution arrangement comprises a conduit in the form of an annular space between the food receiving receptacle and the container.

In another embodiment, the arrangement includes an upwardly extending annular wall and the liquid distribution arrangement comprises a plurality of upwardly extending conduits spaced about, and provided internally of, the annular wall.

In an alternative embodiment a central upwardly extending conduit may comprise the liquid distribution arrangement.

Generally, it is preferred that the liquid distribution arrangement comprises one or more liquid communication conduits permitting liquid communication via the base from the container to the liquid distribution arrangement, and means for delivering liquid from a plurality of radial locations.

In one embodiment it is preferred that the lid is provided with means for engaging with an open end of a conduit comprising the liquid delivery arrangement, which engagement plugs or closes the open end of the conduit.

According to a further aspect, the invention provides food heating apparatus comprising:

a container for containing liquid, the container including a base and one or more sidewalls extending upwardly from the base;

a liquid distribution arrangement situated internally of the container, for raising the liquid held in the container to be distributed over a food heating zone;

wherein the arrangement defines an enclosure about the food heating zone.

In this aspect, it is preferred that the liquid distribution arrangement comprises a base plate, upon which the food may rest, the base plate being provided with an aperture or series of apertures communicating through the upper surface of the base plate for distributing the heated liquid over the food to be heated.

The container may comprise a saucepan configured to be used on a conventional cooker ring. Alternatively the container may comprise a thermally insulating, waterproof vessel and, optionally, the device may have an integrated heating element such that a conventional hob is not required. In yet another exemplary embodiment, the container may comprise a microwavable container to be heated with a microwave oven.

Preferably, the base of the food receiving receptacle has at least one drainage hole.

To operate the cooking device a water reservoir at the base of the container is heated and as water begins to boil at the bottom of the reservoir, ascending bubbles force liquid up the liquid delivery arrangement to be distributed over the food heating zone. The cycle repeats continually until the end result has been achieved.

Advantages of the device according to an embodiment of the invention include that the amount of water used is only that required to flow over the foodstuff in a continuous stream and then to be recycled.

Additionally the heating time to reach the stage where the water flows to be distributed over the food heating zone is around half the time taken to boil the water as required in the standard cooking method. Therefore the food is cooked more quickly using a device according to the invention. This, along with the fact a reduced amount of water may be used, reduces the amount of energy required to heat the foodstuff. Also, flavour and vitamin retention of the food can be enhanced if cooking occurs at a temperature slightly below full boiling.

These and other aspects of the invention will be apparent and elucidated with reference to the embodiments described herein.

Various embodiments of the invention will now be described, by way of examples only and with reference to the accompanying drawings, in which:

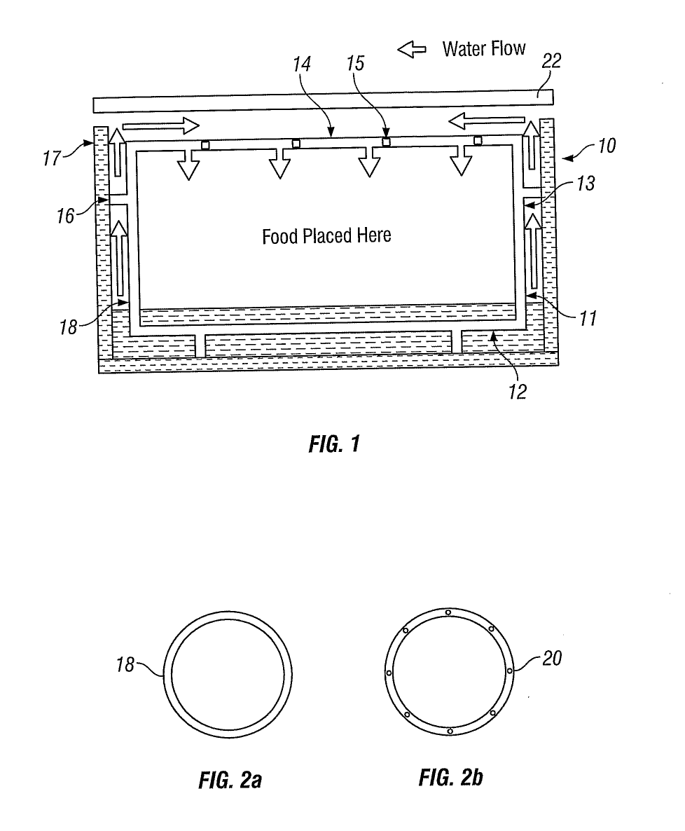

FIG. 1 is a schematic illustration showing the cross sectional front view of a first embodiment of a cooking arrangement according to the invention;

FIG. 2a is a schematic plan view of the percolation channel of the arrangement of FIG. 1;

FIG. 2b is a schematic plan view illustrating the percolation channels of a cooling device according to an alternative exemplary embodiment of the invention;

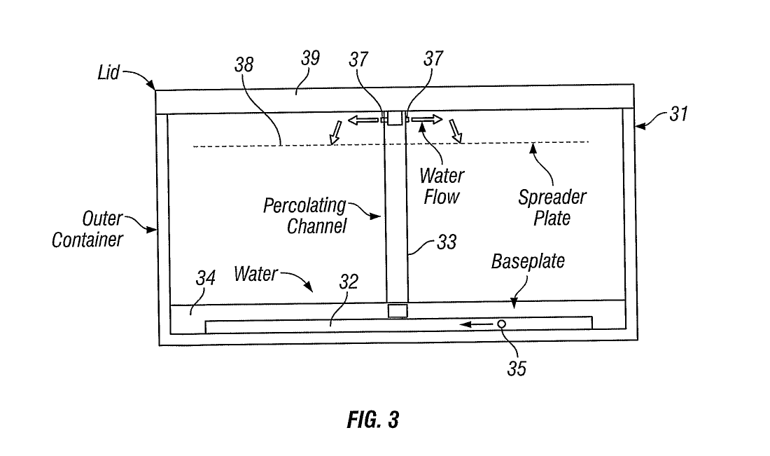

FIG. 3 is a schematic view of an alternative embodiment of cooking arrangement in accordance with the invention;

Referring to FIG. 1 of the drawings, the cooking arrangement 10 consists of an outer container 17 and seated in the outer container 17, receptacle 11 comprising a circular flat base plate 12 having at least one drain aperture between the upper and lower sides of the base plate. At the outer perimeter of the base plate 12, is a sidewall 13 orientated such that it extends upwards from the base plate 12. A detachable flat circular percolation plate 14, having a plurality of percolation apertures 15, is positioned parallel to the base plate 12 seated on the top edge of the side wall 13. The outer periphery and base of the receptacle has a plurality of protruding elements 16. When fitted in the container 17, the outer edge of the receptacle forms the inner edge of a channel 18, with the inner edge of the container forming the outer edge of the channel 18, said outer edge of the channel extending further in the upwards direction than the inner edge of the channel. As shown in FIG. 2a, this results in an annular gap of uniform width (viewed from above). The annular gap is sufficiently small (typically less than 0.5 cm) that when the water is heated to close to boiling the water rises up the annular gap defining channel 18 and then spreads out over the perforated top plate 14, the hot water percolating down through the apertures 5 and contacting the food to be heated in the food heating zone below the top plate 14. The water then passes through the aperture or apertures in the base plate 12 and into the water reservoir defined by the container 17, for recirculation. A stand (not shown) may rest on the base plate 12 to raise the food above the level of the base plate.

The container 17 may be provided with its own heater (such as an electric resistance heater or electrical element for heating the water in the container). This may be electronically controlled to provide maximum efficiency of energy use. Alternatively the container may be heated on a kitchen oven hob. In this case the arrangement may be fitted into a standard kitchen saucepan, provided that the receptacle 11 is shaped and dimensioned to provide the required annular channel 18.

A lid 22 may be provided to rest on the top of the container 17. This has been found to aid in the distribution of water over the top plate 14 and provide protection against splashing and spurting of the hot water passing up the annular channel 18.

In an alternative exemplary embodiment, and referring to FIG. 2b of the drawings, the percolation channels 20 may be provided distributed around the periphery of the receptacle 11 integrally within the sidewalls 13 of the receptacle 11 (which may or may not then be spaced apart from the inner periphery of the outer container 17).

In the embodiment of FIG. 3, the arrangement comprises an outer container or vessel 31, which may be a bespoke receptacle provided with a heater or a simple saucepan to be heated on a kitchen hob. A hollow delivery conduit 33 extends upwardly from a base plate 32 which rests on the base of the container. The base plate 32 has a peripheral lip, such that a void space is provided on the underside of the base plate. One or more drain apertures 35 are provided through the base plate 32 permitting fluid communication of the water in the container 31 with the void space on the underside of the base plate 32. The delivery conduit 33 at its lower end is provided with an open end communicating with the void space on the underside of the base plate 32. The apertures 35 are below the level of the water 34 in the container 31 and permit fluid communication of the water in the container 31 with the interior of the conduit 33 via the void space on the underside of the base plate 32.

At the upper end of the conduit 33 is provided a series of distribution ports or apertures 37 through which water is distributed to descend on to a percolation plate 38, which is positioned above a food heating zone to distribute hot water over food to be heated (in a similar manner to the embodiment of FIG. 1). In this embodiment a lid 39 is provided to rest on the upper rim of the peripheral wall of the container 31. The lid also engages with the upper portion of the distribution conduit 33, in so doing to close the open upper end of the conduit 33 and also weight down the conduit to press down the base plate 32. The lid is provided with a plug for engaging with the open end of a conduit. In this embodiment the presence of the lid 39 has important benefits in that, without the lid in place the water does not spurt out of the conduit, and also the base plate and conduit assembly is prevented from lifting from the base which would raise the apertures 35 above the level of the water. In other words the water distribution via the conduit 33 and over the plate 38 only occurs when the lid is in place.

In a further embodiment the apparatus may simply comprise a base plate 32, upon which the food may rest, the base plate being provided with an aperture or series of apertures communicating through the upper surface of the base plate for distributing the heated liquid over the food to be heated.

Various features from each of the described embodiments can be substituted for one another to good effect. In each of the embodiments a percolation system is provided to distribute heated fluid over the food in which a heating chamber is formed by the components of the arrangement.

It should be noted that the above-mentioned embodiments illustrate rather than limit the invention, and that those skilled in the art will be capable of designing alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. The singular reference of an element does not exclude the plural reference of such elements and vice-versa. In a device claim enumerating several means, several of these means may be embodied by one and the same item of hardware. The mere fact that certain measures are recited in mutually different dependent claims does not indicate that a combination of these measures cannot be used to advantage.

1. Food heating apparatus comprising:
a container for containing liquid, the container including a base and one or more sidewalls extending upwardly from the base;
a liquid distribution arrangement situated internally of the container, for raising the liquid held in the container to be distributed over a food heating zone from above;
wherein the arrangement defines an enclosure about the food heating zone and further comprises:
a lid arranged to engage with the liquid distribution arrangement to hold the liquid distribution arrangement in place within the container; and/or,
a percolation element positioned above the food heating zone and including a plurality of percolation apertures, the heating liquid being distributed over the percolation element to pass through the percolation element and fall under gravity to heat the food at the heating zone.

2. Food heating apparatus according to claim 1, wherein a food receiving receptacle is located within the container, and the distribution arrangement directs the liquid to flow over a side of the food receiving receptacle and through the percolation element.

3. Food heating apparatus according to claim 1, wherein the liquid distribution arrangement comprises a base portion arranged to rest on the container base.

4. Food heating apparatus according to claim 3 wherein the base portion provides a platform upon which the food to be heated may rest.

5. Food heating apparatus according to claim 3, wherein the base portion is provided with one or more liquid communication conduits permitting liquid communication via the base from the container to the liquid distribution arrangement.

6. Food heating apparatus according to claim 1, wherein the arrangement provides one or more conduits for raising the water from a lower portion of the container to be distributed from above the food heating zone.

7. Food heating apparatus according to claim 6, wherein the one or more conduits are defined at the periphery of the liquid distribution arrangement.

8. Food heating apparatus according to claim 1, wherein a food receiving receptacle is located within the container, and the distribution arrangement comprises a conduit in the form of an annular space between the food receiving receptacle and the container.

9. Food heating apparatus according to claim 1, wherein the arrangement includes an upwardly extending annular wall and the liquid distribution arrangement comprises a plurality of upwardly extending conduits spaced about, and provided internally of, the annular wall.

10. Food heating apparatus according to claim 1, wherein the liquid distribution arrangement comprises one or more liquid communication conduits permitting liquid communication via the base from the container to the liquid distribution arrangement, and means for delivering liquid from a plurality of radial locations.

11. Food heating apparatus according to claim 1, wherein the lid is provided with means for engaging with an open end of a conduit comprising the liquid delivery arrangement, which engagement plugs or closes the open end of the conduit.

12. Food heating apparatus according to claim 1, wherein the lid rests on the rim of the container.

13. Food heating apparatus comprising:
a container for containing liquid, the container including a base and one or more sidewalls extending upwardly from the base;
a liquid distribution arrangement situated internally of the container, for raising the liquid held in the container to be distributed over a food heating zone; wherein the arrangement defines an enclosure about the food heating zone.

14. Food heating apparatus according to claim 13, comprising a base plate, upon which the food may rest, the base plate being provided with an aperture or series of apertures communicating through the upper surface of the base plate for distributing the heated liquid over the food to be heated.
